(19) United States
(12) Patent Application Publication
(10) Pub. No.: US 2010/0272262 A1
(43) Pub. Date: Oct. 28, 2010

(54) Systems and methods for broadcast communication and interface with assets and datasets

(76) Inventors: David Boubion, Tampa, FL (US); Peter Rung, Lutz, FL (US); Mary Claire Ryan, Burr Ridge, IL (US)

Correspondence Address: SCHERRER PATENT & TRADEMARK LAW P.C., 17 E. CRYSTAL LAKE AVE, CRYSTAL LAKE, IL, 60014, US

(21) Appl. No.: 12/592,860

(22) Filed: Dec. 3, 2009

Related U.S. Application Data
(63) Continuation-in-part of application No. 11/508,773, filed on Aug. 23, 2006.
(60) Provisional application No. 60/712,077, filed on Aug. 29, 2005.
(60) Provisional application No. 60/736,268, filed on Nov. 14, 2005.
(60) Provisional application No. 61/204,655, filed on Jan. 9, 2009.

(51) Int. Cl. H04K 1/00

(52) U.S. Cl. 380/270; 380/255

(57) ABSTRACT

The present subject matter relates generally to a notification system adapted to provide real-time wireless notification of a change in condition or state of an asset or data set. More specifically, the present invention relates to a global communication and interface network for instantaneous transmission of information for tracking, monitoring, managing, and interfacing with assets and datasets. Still further, the present invention relates to broadcast communication of a change in condition or state of an asset or data set. In addition, the present invention relates to encrypted broadcast communication.

This present invention claims priority to U.S. patent application Ser. No. 11/508,773, filed Aug. 23, 2006, which claims priority to U.S. Provisional Application No. 60/712,077, filed Aug. 29, 2005 and U.S. Provisional Application No. 60/736,268, filed Nov. 14, 2005, and further claims priority to U.S. Provisional Application No. 61/204,655, filed Jan. 9, 2009, each of these applications incorporated herein in their entireties.

### TECHNICAL FIELD

The present subject matter relates generally to a notification system adapted to provide real-time encrypted wireless notification of a change in condition or state of an asset or data set. More specifically, the present invention relates to a global communication and interface network for instantaneous transmission of information for tracking, monitoring, managing and interfacing with assets and datasets. Still further, the present invention relates to broadcast communication of a change in condition or state of an asset or data set. In addition, the present invention relates to encrypted broadcast communication.

### BACKGROUND

Effective and efficient communication is necessary in this “information age.” Specifically, effective and efficient communication, such as instantaneous or nearly instantaneous communication, is necessary to maintain efficient economies and can play a role in providing and maintaining healthy and secure lifestyles. As technology advances, so does the ability to instantly, or nearly instantly, communicate with mobile individuals anywhere in the world.

Of course, instant communication has been known throughout history, such as with the inventions of the telegraph and telephone, through radio and television, and into the computer age and information age, with the development of advanced communication devices. Examples of these advanced communication devices include, but are not limited to, wireless cellular telephones, satellite phones, personal digital assistants (“PDAs”), pagers, wireless e-mail and internet devices, beepers, dongles, mobile computers, or other like advanced communication devices. These devices allow instantaneous or nearly instantaneous communication of information to individuals no matter their location throughout the world.

Moreover, in this fast-paced era, opportunities arise very quickly. Specifically, opportunities often have very short windows for individuals to act upon them. Oftentimes, effective and efficient communication, such as instantaneous or nearly instantaneous communication, can play a large role in whether an individual has the ability to act on and take advantage of an opportunity.

Windows of opportunity can develop because of a change in the condition or state of an asset or dataset. In general, individuals may want to track, monitor and interface with assets and datasets to determine when there is a change in the condition of the asset or the dataset so as to act upon the change in condition or state of the asset or dataset to take advantage thereof.

For example, an individual may be in the market for a mortgage rate, whereby the mortgage rate or rates constitute a dataset. Specifically, a mortgage loan officer typically receives information from any number of wholesale mortgage loan vendors relating to their latest product offerings, such as mortgage rates. The loan officers must typically sift through these offerings daily and determine which would be best-suited for his or her client list. Moreover, there are days when the mortgage rates can fluctuate rapidly in a very short period of time, such as on days, for example, when the Chairman of the Federal Reserve speaks to Congress. This may equate to hundreds of communications received by the loan officer via fax and e-mail, for example. The loan officer may then have to review a large amount of potentially useless or outdated information. Effective and efficient communication, such as instantaneous or nearly instantaneous communication, as well as the ability to identify key mortgage rates, is necessary to provide adequate mortgage rate information to clients.

In addition, mortgage loan officers require leads and prospects to maintain a healthy business. Oftentimes, mortgage applicants fill out applications and fax or e-mail the requests to the loan officer. The mortgage officer may have a short window of opportunity to act upon this lead to establish a relationship with the individual and provide mortgage information to the individual. However, in most instances, a loan officer must be present in the office to receive the request. Existing communication systems lack the ability to facilitate the linkage of prospective mortgage applicants with loan officers thereby establishing relationships necessary for the loan officers to maintain healthy businesses.

Moreover, one of the most process-intensive, challenging and stressful activities in the realm of procuring a title or loan is the process to approve the title or the loan. A mistake can be costly for the client, the title company, the lender and the lender's reputation. Many times, loan approval and preparation typically rests in the hands of owners or senior executives, who may need to delegate the review of the loan approval, especially when loan information is received late in the day or on a Friday afternoon. Existing communication systems lack the ability to effectively facilitate the title or loan approval process. Effective and efficient communication, such as instantaneous, or nearly instantaneous, communication, of loan approval is, therefore, necessary.

An additional example where effective and efficient communication is useful, if not necessary, is in the realm of procuring real estate. A real estate agent or broker receives real estate sales opportunity information from a number of sources, such as, for example, web sites, e-mails, by telephone, and via other information providers. For example, on a daily basis, an agent or broker addresses these potential sales opportunities and determines which of these would be best suited for listing under their service. Therefore, real estate agents or brokers typically have short windows of opportunity to identify key potential sales opportunities and possibly match potential buyers with the sales opportunity. Oftentimes, real estate agents or brokers are often mobile, and the agents or brokers may not receive the message relating to the sales opportunity for hours. In some cases, the sales opportunity may occur over the weekend, and the agents or brokers may not be informed of the sales opportunity unless they constantly monitor their e-mail or telephone messages. Given the issue of speed with respect to sales opportunities, effective and efficient communication, such as instantaneous or nearly instantaneous communication, is necessary. However, existing communication systems lack the ability to identify and inform prospective buyers of real estate opportunities before the opportunity is lost.

Another example where effective and efficient communication is useful is in the domain of recruitment of jobs. A recruiter is typically given a job description or specification that describes what is required for a job. The recruiter then typically focuses on specific core responsibilities required, and uses this information to start locating the appropriate potential applicants or candidates from a database. With the job description, the recruiter will typically use search words to locate the most qualified candidates. These words are linked and used to search on various databases, such as the web, within job boards or company applicant tracking systems, as well as other systems and technology applications. This linkage is typically known as a “search string.” The recruiter may complete the search string, and apply it to the databases to attempt to find the ideal candidates for the job.

However, recruiters may have short windows of opportunity to match up jobs with these individuals, and time is of the essence when filling jobs. Effective and efficient communication, such as instantaneous or nearly instantaneous communication, and the ability to efficiently match job seekers' skills with available jobs is necessary. Existing communication systems lack the ability to effectively and efficiently link prospective job applicants with recruiters for matching job applicants with jobs.

Effective and efficient communication is further necessary in the healthcare setting. For example, doctors, nurses and other healthcare providers may have very short windows of opportunity to provide adequate and, possibly, life-saving healthcare to sick or injured individuals. Specifically, a healthcare professional, such as a nurse, doctor, or other healthcare provider, may examine a patient and/or tests conducted, such as blood work, x-rays, or other tests, and may determine that the results dictate that the patient requires immediate attention. Existing communication systems lack the ability to provide instant communication between healthcare providers for providing adequate healthcare to sick or injured individuals. Specifically, most doctors must be present at the hospital or healthcare facility, or ask a nurse's station or other department to page him or her when there is a change in the patient's vitals, along with the receipt of test results. In addition, most doctors receive pager or beeper alerts through a third party service company, which can cause delays in allowing the doctor or other healthcare provider to determine the patient's next steps in receiving care. Delays in the healthcare industry may mean the difference between life and death. Moreover, there may not be adequate numbers of healthcare professionals to effectively monitor patients. Moreover, on-site healthcare professionals may not have the proper skill or training to understand the importance of beeping or paging the doctor at critical times. Effective and efficient communication, such as instantaneous or nearly instantaneous communication, is therefore necessary in the healthcare industry.

Instant communication can further be useful for securing assets, such as property assets, whether physical or virtual. With the increase in theft, most individuals are concerned about securing not only their home but also their cars, boats, motorcycles, all-terrain vehicles, construction equipment, asset shipments, transportation containers and/or cabs (i.e., rail or shipping), any other physical assets, and even information assets. Existing security systems utilize standard phone lines or the internet for communicating and interfacing with the system. However, the existing security systems lack the ability of instantaneous or nearly instantaneous transmission of security information to remote receivers for tracking, monitoring and interfacing with secured assets.

Instant communication is further useful when communicating with more than one individual. For example, while it may be important for one person to instantly communicate with another, it may be extremely important to be able to instantly communicate with a group of people to tell each person the same information.

Moreover, although broadcast communication may be useful, the potential for security breaches may rise when the size of a group of communication recipients increases. It may be important to ensure that the information that is communicated to the large group of people be maintained privately and with security.

A need, therefore, exists for a communication system and method. Specifically, a need exists for a communication system and method that allows an individual to interface with and monitor an asset or data set, and allows for effective and efficient communication, such as instantaneous or nearly instantaneous communication, when there is a change in the condition or state of the asset or dataset.

Moreover, a need exists for a communication system and method that provides instant or nearly instant broadcast communication to a group of individuals based on the change of a condition or state of an asset or data set. Still further, a need exists for a communication system and method that provides robust encryption of broadcast communication.

### SUMMARY OF THE INVENTION

The present subject matter provides a monitoring, communication and interface system and method. The monitoring, communication and interface system and method of the present subject matter utilizes existing wireless communications networks such as, but not limited to, WiFi, WiFi long distance, cellular, short message service (“SMS”), and/or satellite to communicate information to a variety of receivers including cell phones, beepers, personal digital assistants (PDAs), fobs, such as car key fobs or key tags, and the like. A transmitter may be associated with an asset or data set and a corresponding receiver may be provided as a stand-alone device or may be included in a user's existing wireless communication device, such as a cell phone or other device. The transmitter may further include a Global Positioning System (“GPS”) receiver, which enables use of the GPS network to track an asset, for example, in the case of a theft of the asset. The receiver may include an alarm, which may enable the device to produce an audible, visual or vibrational signal. Further, the present subject matter provides a system and method for real-time tracking, monitoring and interfacing with assets and data sets.

An advantage of the monitoring, communication and interface system and method is its use of commonly used devices to receive communications from and/or interface with an asset or dataset monitoring system, thereby reducing the cost of implementation and reducing the number of items to be carried by the user.

Another advantage of the monitoring, communication and interface system and method is the instantaneous or nearly instantaneous transmission of information to the asset owner, whether the asset is a physical asset, virtual asset, information or dataset.

A further advantage of the monitoring, communication and interface system and method is a user's direct contact with the receiving device, which enables direct communication to the user, as opposed to through an intermediary.

Yet another advantage of the monitoring, communication and interface system and method is its potential to reduce insurance costs to the individual by increasing security and reducing and/or deterring theft of an asset.

An additional advantage of the system and method of the present invention includes the ability to send one or more messages to a group of individuals. In addition, an advantage of the present invention includes the ability to send one or more messages to a group of individuals regarding the change of condition or state of an asset or data set. Moreover, an advantage of the present invention is to provide an instant or nearly instant broadcast communication to a group of individuals that is encrypted. Still further, an advantage of the present invention is to provide encrypted broadcast communication to a group of individuals, where the encryption is unique to each individual thereby providing heightened security of the communication.

Additional objects, advantages and novel features of the invention as described below and in the examples will be set forth in part in the description which follows, and in part will become apparent to those skilled in the art upon examination of the following description and the accompanying drawings or may be learned by production or operation of the examples.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a schematic illustrating a system in an embodiment of the present invention.

FIG. 2 illustrates a schematic showing a method in an embodiment of the present invention.

FIG. 3 illustrates a schematic showing a broadcast encryption system in an embodiment of the present invention.

### DETAILED DESCRIPTION OF THE PRESENTLY PREFERRED EMBODIMENTS

The present subject matter provides a monitoring, communication and interface system and method. The monitoring, communication and interface system and method of the present subject matter may utilize existing wireless communications networks such as, but not limited to, WiFi, WiFi long distance, cellular, short message service (“SMS”), and/or satellite to communicate information to a variety of receivers including cell phones, beepers, personal digital assistants (PDAs), fobs, such as car key fobs, key tags and the like. A transmitter may be associated with an asset or data set and a corresponding receiver may be provided as a stand-alone device or may be included in a user's existing device, such as a cell phone or other device. Communication made according to the present invention is, preferably, encrypted, as described in further detail herein.

The transmitter may further include a Global Positioning System (“GPS”) receiver, which enables use of the GPS network to track an asset, for example, in the case of a theft of the asset. The receiver may include an alarm, which may enable the device to produce an audible, visual or vibrational signal. Further, the present subject matter provides a system and method for real-time tracking, monitoring and interfacing with assets and data sets.

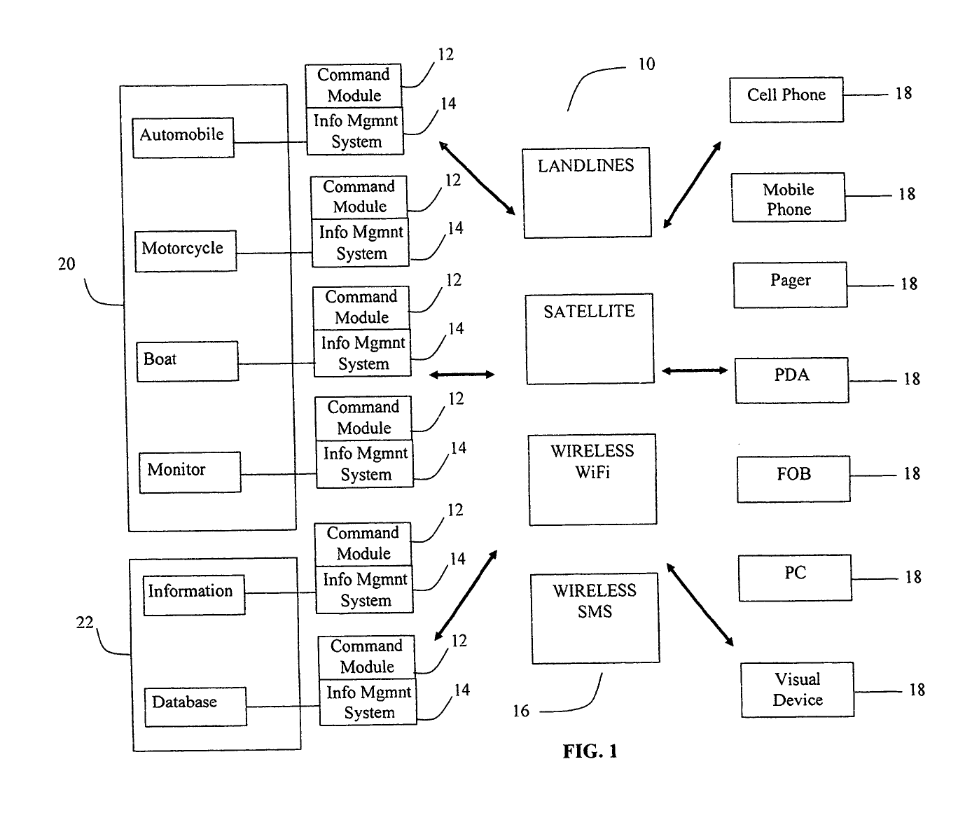

FIG. 1 illustrates a monitoring, communication and interface system 10 whereby a command module 12 integrates with an information management system 14 to communicate via one or more information transmission systems 16 to a receiver 18. The information management system 14 may be a hardware or software system that monitors a physical asset 20 or an information asset 22. The information transmission system 16 may include, but may not be limited to, WiFi, WiFi long distance, cellular, short message service (“sms”), and/or satellite network or system. Alternatively, the information transmission system 16 may include other communication systems capable of instantaneous or nearly instantaneous one-way or two-way communications. The receiver 18 may be a portable device, such as, but not limited to, a cell phone, pager and beeper, PDA, wireless e-mail or internet device and/or a fob. Any asset, whether physical or informational, associated with an electronic monitoring system may be utilized in the monitoring, communication and interface system 10.

The command module 12 may be integrated into a housing, such as a cradle, and may include direct current (DC) power connections, as well as an onboard battery to maintain continual operation in case of main power disconnect. Alternatively, the command module 12 may be incorporated directly into the information management system 14 or the asset itself. The command module 12 may further include a Global Positioning System (“GPS”) receiver, which enables use of the GPS network to track an asset, for example, in the case of a theft of the asset.

The command module 12 may include a hardware detection component and/or a software detection component. The hardware detection component is adapted to detect hardware actions that trigger conditions within the information management system 14 based on a protocol designated by the command module 12. The triggered condition may be, for example, an alarm condition or another condition that may become activated when there is a change in condition or state of the asset. For example, if the information management system 14 is designed to trip an alarm when a vehicle door is opened, the hardware detection component of the command module 12 is triggered and sends an alert to the receiver 18. The vehicle may constitute the asset and the opening of the vehicle door may constitute the change in condition or state of the asset. In one example, the hardware detection component of the command module 12 may integrate into the information management system 14 hardware through a two wire interface into audio detection circuitry. Audible noise may trigger the alert sent to the receiver.

The software detection component includes an application programmer interface that is adapted to integrate with the software component of the information management system 14. The software detection component may be adapted to sense a change in the condition or state in the software component of the information management system 14 and send a corresponding communication to the receiver 18. For example, the software detection component may sense an alarm condition in the information management system 14 software. In one example, the software detection component of the command module 12 may integrate into the software command layer of the information management system 14 through a two wire interface. The application programmer interface may utilize a series of serial-based commands using, for example, RS-232, to communicate with the information management system 14 in an acknowledgement/non-acknowledgement software architecture. Alternatively, the application programmer interface may utilize any software architecture or platform that is compatible with the information management system 14.

In one example, the application programmer interface commands may include: “initialize,” “validate,” “communication option,” “enter registration information,” “register,” “send message” and “exit” commands. The “initialize” command may be used to connect and initialize the command module 12, for example, when associating the command module 12 with the information management system 14 during an installation of the monitoring, communication and interface system 10. The “validate” command may be used to validate an external signal, such as, for example, a signal from the information management system 14, a signal generated by a change in condition or state of an information asset or the receiver 18. The “communication option” command may be used to select a communications option, for example, to select one or more information transmission systems 16 to be used for communications between the command module 12 and receiver 18. The “enter registration information” command may be used, for example, to input registration information into the command module 12 to be transmitted to the monitoring, communication and interface system 10 manufacturer and/or technical support. The “register” command may be used, for example, to transmit the information input using the enter registration information command. The “send message” command may be used, for example, to send information and/or emergency messages to the receiver 18 or another monitoring device. The “exit” command may be used, for example, to disconnect the command module 12 from the information management system 14.

As described above, the receiver 18 may be a portable wireless device carried by the user for monitoring or communicating with the command module 12. The receiver 18 may provide a user with a visual, audible or vibrational signal to indicate a communication has been received from the command module 12. The receiver 18 may be a stand-alone device or may be incorporated into another device. For example, the receiver 18 may be incorporated into a user's cell phone, such that the user's cell phone may ring, vibrate or flash when a communication is received from the command module 12. Similarly, the receiver 18 may be incorporated into a vehicle key fob or key tag. The key fob receiver 18 or other receiver 18 may be specially adapted to be incorporated into the monitoring, communication and interface system 10. Alternatively, the key fob receiver 18 or other receiver 18 may be retrofit to be used within the monitoring, communication and interface system 10. The receiver 18 may be battery powered or may be otherwise powered to maintain operation in remote and mobile situations. In one example, the receiver 18 may be in continuous search for an alarm signal or other communication from the command module 12.

The command module 12 and receiver 18 may communicate using one or more of the information transmission systems 16 described above. For example, in one example, the command module 12 and receiver 18 communicate with each other using WiFi long distance, cell and/or satellite communications. Moreover, the command module and receiver 18 may be in two-way communication such that each may transmit and receive communications from the other. Accordingly, operational instructions may be communicated in either direction. For example, the receiver 18 may include an alarm shut-off or override control to allow a user to enable/disable the information management system 14 from a remote location.

The monitoring, communication and interface system 10 may be used to track or find people, such as children or elderly people. The monitoring, communication and interface system 10 may be adapted to monitor the location of a person using, for example, GPS technology, and send a communication to a receiver 18 if the monitored person leaves a designated location. Accordingly, the communications provided to the receiver 18 allow real-time tracking and monitoring of another person.

Another embodiment of the monitoring, communication and interface system 10, described above, focuses on the tracking, monitoring and interfacing with an information asset 22 or dataset utilizing the command module 12, information management system 14, transmission systems 16 and receiver 18, as shown in FIG. 1. In the embodiment shown in FIG. 1, the monitoring, communication and interface system 10 includes the information asset 22, the command module 12, the information management system 14, information transmission system 16 and receiver 18. The command module 12 and information transmission system 16 may be adapted to monitor, communicate and interface with the information asset or other dataset, such that the command module 12 may be provided software integrated within the information asset. The monitoring, communication and interface system 10, as shown in FIG. 1, can be used in any context wherein monitoring, communicating and interfacing with an asset is desired. The asset may be monitored by the monitoring, communication and interface system 10. When a change in condition or state occurs within the information asset or if the information asset satisfies a condition or threshold, the monitoring, communication and interface system 10 recognizes the change via its monitoring capability communicates the change in condition or state via its communicating capability and allows interfacing with the information asset via its interfacing capability.

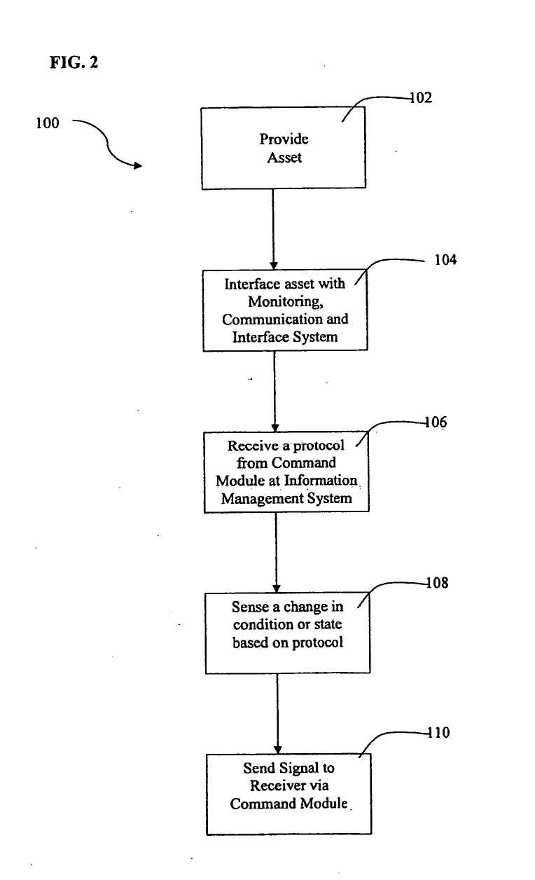

FIG. 2 illustrates an embodiment of a method 100 illustrating steps for using the monitoring, communication and interface system 10. Specifically, the method 100 includes a step 102 of providing an asset to be monitored for a change in condition or state thereof. As described above, the asset may be a physical asset or an information asset, such as a dataset or other information. The monitoring, communication and interface system 10 interfaces with the asset via step 104. The interface may include, but is not limited to, placement of a hardware component on a physical asset 20, such as placing a sensor on the physical asset 20 to monitor a physical change in condition or state of the asset. Alternatively, the interface may include a software component, wherein a sensor system is programmed into the infrastructure of an information asset 22.

As described above, the monitoring, communication and interface system 10 may include two modules tied together to control the monitoring, communication and interface system 10 and monitor an asset: 1) a command module 12 (for controlling the system 10); and 2) an information management system 14 (for monitoring the asset). The command module 12 may generate instructions in the form of a protocol that is received by the information management system 14 via step 106. The protocol provides instructions to the information management system 14 for monitoring the asset and sensing a change in condition or state of the asset.

When there is a change in condition or state of the asset such that it satisfies the protocol designated by the command module 12, the change in condition or state of the asset is sensed by the information management system 14 via step 108 and recognized as a change in condition or state.

The command module 12 may then send a signal to the receiver 18 via the information transmission system 16 via step 110. As described above, the information transmission system 16 may be any system or network for communicating with the receiver 18. The signal may contain information helpful to alert an individual about the change in condition or state of the asset. The signal may be a warning, such as a security warning, alerting an individual that a theft of property is in progress, or may merely be information, alerting an individual to an opportunity the individual may wish to take advantage of.

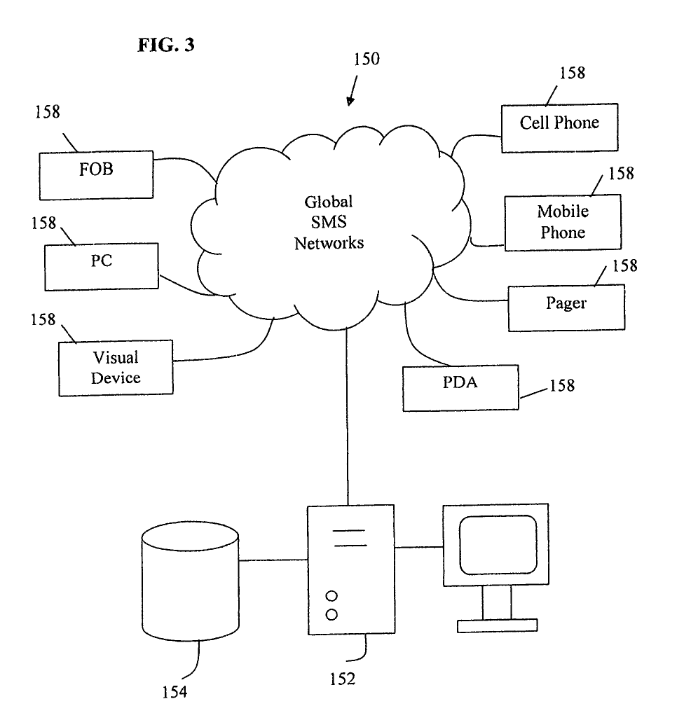

In a further embodiment of the present invention, FIG. 3 illustrates a schematic of a broadcast communication system 150. The broadcast communication system includes a server 152 connected to a user database 154. The server 152 manages a plurality of users in an account. Specifically, the server 152 manages the group of users with the ability to encrypt inbound and outbound messages. In a non-limiting example, the server 152 encrypts inbound and outbound text messages sent via global SMS networks 156 as provided by various carriers throughout the world.

The server 152, coupled with the user database 154, manages user contact information and groups users together based on a commonality. For example, specific users may be grouped based on the users' desire to be informed about a change in condition or state of a particular asset or data set, as described above. The server 152 may have multiple accounts based on a general grouping criteria, and each account may have a plurality of groups based on more specific grouping criteria. Each group may have a plurality of users based on their general and specific grouping characteristics. The server 152 manages contact with users within the specified groups.

Communication to and from particular user's first pass through the server 152 prior to terminating at the users' communication device. Examples of communication devices, as demonstrated in FIG. 3 as 158 include, without limitation, cell phone or other mobile phone not using cellular technology, a pager, a PDA, a Fob, a personal computer, including a desktop, laptop, or handheld computer, or some other visual device that allows text messages to be displayed thereon.

An incoming text message sent via a global SMS network that is to be received by a user is received at the server 152, the contact information of the user being held in the user database 154. The message may then be encrypted and sent to the intended user. Based on the grouping of the user with other common users, the text message may be sent to all users within a defined group, or to an entire account. Each message sent to the user, the group or the account is encrypted.

Encryption on the server 152 may be accomplished requiring multi-factor authentication on the user's client product, such as cell phone and the like. Therefore, each message sent to a group of users, or to the account, may be uniquely encrypted for each individual user. A response generated by a user is also uniquely encrypted and sent back to the server 152 for decryption and submission to its ultimate destination.

Each user's client device includes a software or hardware product installed thereon for decryption and encryption of text messages. If software, the product may be installed via an administrator or via an automated download. If hardware, the product may be attached or otherwise interconnected with the user's client device.

The software or hardware product may operate in either of two ways. First, the product may intercept an incoming text message and analyze to determine whether it is encrypted. If encrypted, the software or hardware product may require authentication by the user prior to decryption, such as via password or other authentication means. Alternatively a smart token may be incorporated with the software or hardware product that provide automatic authentication.

Second, the product may analyze a plurality of text messages stored within a text message database, thereby decrypting any encrypted message stored within the text message database.

The software product may encrypt all outgoing messages that are then immediately sent to the server 152. The server 152 decrypts the text message on the server side and sends the message to its intended recipient.

The server maintains logs of all activity via a command console. The command console provides the mechanism for the complete administration of the server database system and provides a user interface for a message administrator to configure users, groups, accounts, keys, predefined messages, queues and encryption mechanisms.

The initiation of an encrypted message may occur at the server command console, or it may originate at the mobile client through encrypted messages which trigger an action within the server. This action may include, but is not limited to, sending one or more predefined messages, forward one or more messages to a group, forward one or more messages to a user, and/or forward one or more messages to the message administrator.

The encryption/decryption takes place in both the client software and the server. The encryption may include algorithms including, but not limited to, AES, blowfish, twofish and DES. The encryption bit width may include, but is not limited to, 64 bit up to 2048 bit; although other bit widths are contemplated by the present invention and should not be limited as herein described.

The embodiment described herein allows encrypted broadcast messages to be sent from the server 152 and individual users' communication devices 158. Moreover, the embodiment described herein allows encrypted messages from users back to the server 152 to be decrypted prior to being received by the intended recipients. Therefore, this encryption/decryption scheme provides increased security of broadcast communications.

### EXAMPLES

The following examples are provided to illustrate specific applications of the above-described invention, and are not meant to be limiting in any way.

### Example 1

In a first non-limiting example, the monitoring, communication and interface system 10 shown in FIG. 1 can be adapted for use within the real estate context. Real estate listings are often provided on the internet or other computer network and associated with a specific real estate agent. The real estate listing can be the information asset in the monitoring, communication and interface system 10. When an inquiry related to the real estate listing is made, the information management system 14 recognizes the inquiry and the command module 12 sends a communication to the real estate agent. For example, the command module 12 may send an SMS message to the real estate agent's cell phone, or other receiver 18, providing the real estate agent an identifier for the listing, such as, for example, the property address, and the name and phone number of the inquirer. Accordingly, the real estate agent can be provided this notification within seconds of the inquiry being made on the website. The notification is, therefore, instantaneous or nearly instantaneous. If the real estate agent does not respond to the communication within a predetermined period of time, the command module 12 may send another communication to a second real estate agent within the same brokerage office in order to provide improved customer service and keep potential sales within the brokerage office.

### Example 2

In a second non-limiting example, a real estate agent or broker may submit criteria to the command module 12, shown in FIG. 1, relating to a request for sales opportunities. An invitation may be provided on a web site to complete a form relating to a real estate sales opportunity. The information management system 14 may monitor the website for a submission of the form. Once a form is submitted to the website, an alert may be triggered by the command module, which is contained within the website software that instantly communicates the information relating to the submission to the receiver 18 of the agent or broker through the information transmission system 16. The agent or broker can receive the alert and/or may receive other information, such as contact information and/or information relating to the real estate sales opportunity, on the agent's or broker's receiver 18, which may be the agent's or broker's cell phone, wireless e-mail device, pager, beeper, PDA, or other like receiver. Once received by the agent or broker, the agent or broker may immediately contact the individual regarding the sales opportunity. The agent or broker need not, therefore, be physically present within their office to receive the notice.

### Example 3

Similarly, the monitoring, communication and interface system 10 shown in FIG. 1 may be adapted for use in the health care industry. For example, a patient's electronic file may be the information asset. When information within the electronic file changes condition or state, such as, for example, when a patient's status changes for the worse, the command module 12 communicates the change in condition or state to the doctor's pager, cell phone PDA, wireless e-mail device, or other communication device. The communication may include codes regarding the change in condition or state and an identifier to indicate the patient with which the message relates. Accordingly, the command module 12 can provide more information to the doctor than known paging services and may allow the doctor to receive enough information to take action, such as, send a return message, without requiring a phone call in response to a page or other message. Further, the command module 12 can send a message to another doctor if the first doctor does not respond within a predetermined period of time.

For example, a doctor may have a patient in the Intensive Care Unit (“ICU”) at a hospital, and may want to monitor the patient's vital signs. The information management system 14 would be set by the command module 12 to electronically monitor the patient's vital signs. In many cases, a central management console within a hospital or other healthcare facility contains related vital information on patients, such as a patient in the ICU. When a condition or state of one or more vital signs changes or breaches a threshold, an alert may be sent by the command module 12 to the doctor's communication device, such as the doctor's cell phone, beeper, pager, PDA, or other communication device alerting the doctor to the change in the condition or state. Once the information is received by the doctor, the doctor may respond thereby instructing the nurse or other healthcare provider regarding the next course of action.

### Example 4

Similarly, the monitoring, communication and interface system 10 shown in FIG. 1 may be adapted for use in the mortgage industry in an alternate non-limiting example. Mortgage rate information may be monitored and stored in a central database in real-time. The database may be the information asset. The mortgage database is monitored in real-time by the information management system 14. When monitored loan information changes, a message can be sent to the mortgage broker's receiver 18 by the command module 12. For example, the communication may be an SMS message or an e-mail communication including the relevant information. This allows the broker to be provided with information when the rate information changes, or when the rate information reaches or crosses a threshold value. The broker may then be able to determine which of the new rates to provide to his or her prospects immediately.

### Example 5

In another non-limiting example in the realm of receiving effective and efficient communication with respect to mortgages, a loan officer may set the information management system 14 to monitor an internet website for the receipt of inquiries relating to loans via the command module 12. When an inquiry request is received by the website, an alert or other communication is sent to the loan officer's receiver 18, along with contact information and/or other information relating to the inquiry by the command module 12. The loan officer may then immediately contact the prospect.

### Example 6

In a still further non-limiting example of the present invention, the information management system 14 may be set by the command module 12 to alert a senior executive of a mortgage company when authority to release funds for a mortgage funds is received. When out of the office, the senior executive may receive an alert from the command module 12 on his or her receiver 18, and may instantly communicate approval of the loan based on the alert.

### Example 7

In another non-limiting example, the monitoring, communication and interface system 10 shown in FIG. 1 may be adapted for use in the recruiting or job searching industry. For example, an applicant may submit, via a website or other network system, a resume or other application. The resume or other application may constitute the information asset. The information management system 14 may monitor the submissions and the recruiter may be notified by the command module 12 in real-time when an application is submitted that meets certain predetermined requirements. For example, the notification may be sent whenever an application is made that meets predetermined minimum qualifications or that includes a predetermined key word or phrase. Alternatively, notification may be sent at predetermined intervals and include information relating to most highly qualified applications. Moreover, an electronic search agent may be used to parse the applications for relevant submissions.

A recruiter may set the information management system 14 via the command module 12 to alert him or her when one or more applicants submit applications matching a specified search string, which typically includes phrases and key words relating to the job requirements. When an applicant submits an application that matches or closely matches the search string, an alert may be provided by the command module 12 to the recruiter's receiver 18 informing the recruiter of the match. Moreover, specific information may be provided to the recruiter, such as contact information, and other information relating to the applicant's application, so that the recruiter may immediately contact the applicant.

For example, a recruiter within a hospital may attempt to fill many types of job openings for nurses. The recruiter may, during the day, conduct searches utilizing the search string. The recruiter, for example, may be looking for an oncology nurse in pediatrics located in Chicago with 5 years of experience. A very few number of matching candidates may apply, and not necessarily during business hours, by submitting their application via a website form. The information management system 14 monitors the website for applications with matching characteristics and the command module 12 immediately alerts the recruiter's receiver 18 when the matching applicants submit their forms, and the recruiter contacts the applicants immediately.

### Example 8

In another alternate non-limiting example of the present invention, the monitoring, communication and interface system 10 is interfaced with a property asset, such as, but not limited to, a home, a car, a boat, a motorcycle, an all-terrain vehicle, construction equipment, an asset shipment, a transportation container and/or cab (i.e., rail or shipping), and any other article deemed important or in need of security to prevent or deter theft thereof. When there is a change in condition or state with respect to the property asset, the information management system 14 monitors the change in condition or state and the command module 12 provides an alert that is effectively and efficiently communicated to the receiver 18. The communication may be instantaneous or nearly instantaneous. The change in condition or state may involve tampering with the property asset in such a way as to trigger the information management system 14. Alternatively, an alternate protocol may involve wirelessly alerting a third party, such as a security company, or other individual.

For example, most individuals lock their automobiles while shopping, going to the movies or any other activity which requires the individual to leave the car unattended. Many cars have a key tag attachment that may be utilized to open and close the doors of the car. An alarm may be embedded within the key tag, such that when the information management system 14 recognizes a change in condition or state of the cars, such as a breach of the car door, for example, the command module 12 wirelessly triggers an alarm within the key tag. The alarm within the key tag would sound, buzz or vibrate instantaneously, or nearly instantaneously, to alert the car owner that a potential theft or breach in security was occurring. Alternatively, the car owner could receive an alert on their cell phone, beeper, pager, PDA, wireless e-mail device, or any other device that could act as a receiver 18, whereby the car owner could receive the alert instantaneously, or nearly instantaneously.

### Example 9

A container containing important property assets may be shipped from a place of origin to a destination. The transportation mechanism may be, for example, sea, air, rail truck or any other transportation mechanism. The condition or state of the property assets may be monitored by the information management system 14, which may instantaneously, or nearly instantaneously, send a wireless alert signal to a receiver 18, which may be kept by the owner or other party responsible for the property assets, when the property assets are tampered with.

### Example 10

In a still further non-limiting example, a company may operate a datacenter thereby maintaining information for a company on a host of servers, mainframes, or other like computing devices. The company may wish to tightly secure access to the datacenter. The information management system 14 may be physically interfaced with the datacenter or virtually interfaced with the datacenter, such that any abnormal change in condition or state with the physical components of the datacenter and/or virtual components of the datacenter is sensed by the information management system 14 and the command module 12 instantaneously, or nearly instantaneously, sends a wireless alert to the receiver 18, which allows a party to immediately act to protect the contents of the datacenter.

### Example 11

Similarly, the monitoring, communication and interface system 10 shown in FIG. 1 can be adapted for use in the financial services industry. For example, the information could be a financial portfolio of any kind which may be a client's electronic filing of a physical asset, e.g. a stock certificate, but is represented as part of a larger information file, which represents the value of the portfolio. When information within the electronic file changes condition or state, such as, for example, when the value of the asset falls below a certain level, the command module 12 communicates the change in condition or state to the portfolio manager's pager, cell phone PDA, wireless e-mail device, or other communication device. The communication may include codes regarding the change in condition or state and an identifier to indicate the portfolio asset merits a related or specific message.

Accordingly, the command module 12 can provide more information to the manager than known paging services and may allow the financial portfolio manager enough information to take action. Such response action would include, but is not limited to, sending a return message by text or other methodology apparent to one having ordinary skill in the art. This response action does not require a phone call in response to the page, text message or other communication. Further, the command module 12 can send a message to another financial manager if the first manager does not respond within a predetermined period of time. The predetermined period of time would be previously determined by the financial institution or the group of portfolio managers.

Further details of this financial solution could include the following non-limiting examples: A manager may wish to monitor a specific or group of clients' portfolio for financial changes, stability, or other metrics predetermined by the manager. The information management system 14 would be set by the command module 12 to electronically monitor the client's financial portfolio changes and metrics. In many cases, a central management console within a financial institution contains related vital information on clients. When a condition or state of one or more financial portfolio changes or reaches predetermined thresholds, an alert may be sent by the command module 12 to the financial manager's communication device, such as the cell phone, beeper, pager, PDA, or other communication device alerting the financial manager to the change in the condition or state of said client's portfolio. Once the information is received by the manager, the manager may respond thereby instructing an aid.

Another methodology would be that a specific investor, bank client, insurance client or other individual may wish to monitor his or her combined financial portfolio for financial stability, which may include individual elements for a combined portfolio, or the entire portfolio itself. The information management system 14 would be set by the command module 12 to electronically monitor his or her financial portfolio for positive or negative changes. In many cases, a central management console within a financial institution contains related vital information on clients, which may or may not be accessible by the client. When a condition or state of one or more changes or reaches certain predetermined thresholds, an alert may be sent by the command module 12 to the manager's communication device, such as the cell phone, beeper, pager, PDA, or other communication device alerting the manager to the change in the condition or state. Once the information is received by the investor, the investor may respond thereby instructing the system regarding the next course of action.

As shown, the monitoring, communication and interface system 10 shown in FIG. 1 may be employed in any circumstances wherein real-time monitoring and communication of information is desired, whether the change in information or status is a permitted or an unpermitted change in condition or state.

### Example 12

A further example includes a broadcast communication designated for a group of individuals that is united based on a predefined commonality. For example, a plurality of users may be interested in obtaining information about an asset that is for sale. A monitoring system may be utilized to monitor the price of a particular asset. When the price of the asset reaches a certain predefined level, a broadcast message may be sent to the plurality of individuals having the predefined commonality—that is, desiring to be informed when the asset reaches the predefined level.

Moreover, the broadcast communication may be individually encrypted to each respective individual that receives the broadcast message, such that others who may receive the message will not be able to read the same.

It should be noted that various changes and modifications to the presently preferred embodiments described herein will be apparent to those skilled in the art. Such changes and modifications may be made without departing from the spirit and scope of the present invention and without diminishing its attendant advantages.

We claim:

1. A communication system comprising:
a server for managing communications among users of the server;
a plurality of users managed by the server; and
a message generated by a first user, wherein the message is sent to the server wherein the server encrypts the message to form an encrypted message and further wherein the server sends the encrypted message to the plurality of users managed by the server.

2. The communication system of claim 1 wherein the server generates a first encrypted message and sends the first encrypted message based on the message to a first user managed by the server, and further wherein the server generates a second encrypted message based on the message and sends the second encrypted message to a second user managed by the server, wherein the first encrypted message and the second encrypted message are encrypted differently.

3. The communication system of claim 1 wherein at least two of the plurality of users managed by the server are categorized into at least one group, wherein the encrypted message is sent to only the users within the group.

4. The communication system of claim 1 wherein the server intercepts a message having a plurality of intended recipients and further wherein the server determines whether the message is encrypted.

5. The communication system of claim 4 wherein the server automatically decrypts an intercepted encrypted message to form an unencrypted message and further sends the unencrypted message to the intended recipients of the message.

6. The communication system of claim 4 wherein the server identifies an encrypted message having a plurality of intended recipients and further wherein the server prompts at least one of the intended recipients of the encrypted message to authenticate an identity of the at least one of the intended recipients and further wherein the server decrypts the message based on the authentication of the identity.

7. The communication system of claim 1 wherein the message is selected from the group consisting of an SMS message, a video message, an audio message, and combinations thereof.

8. A method of communicating between users on a server comprising the steps of:
providing a server for managing communications between users of the server;
generating a message by a first user managed by the server;
sending the message to the server;
encrypting the message at the server to form an encrypted message; and
sending the encrypted message to a plurality of users managed by the server.

9. The method of claim 8 further comprising the steps of:
generating a first encrypted message;
sending the first encrypted message to a first user managed by the server;
generating a second encrypted message; and
sending the second encrypted message to a second user managed by the server,
wherein the first encrypted message and the second encrypted message are encrypted differently.

10. The method of claim 8 further comprising the steps of:
categorizing a plurality of users into at least one group; and
sending the encrypted message to the users within the group.

11. The method of claim 8 further comprising the steps of:
intercepting a message at the server, wherein the message is sent to one or more users managed by the server; and
determining whether the message is encrypted at the server.

12. The method of claim 11 further comprising the steps of:
automatically decrypting an encrypted message having an intended recipient at the server to form an unencrypted message; and
sending the unencrypted message to the intended recipient of the encrypted message.

13. The method of claim 11 further comprising the steps of:
identifying an encrypted message at the server wherein the encrypted message has a plurality of intended recipients;
prompting at least one of the intended recipients of the encrypted message to authenticate an identity of the at least one intended recipients;
decrypting the encrypted message based on the authentication of the identity to form an unencrypted message; and
sending the unencrypted message to the at least one intended recipient.

14. The method of claim 8 wherein the message is selected from the group consisting of an SMS message, a video message, an audio message, and combinations thereof.

15. A monitoring, communication and interface system comprising:
an asset having a condition;
an information management system for monitoring the asset;
a communication system associated with the command module; and
a plurality of portable wireless receivers associated with the communication system wherein a communication is automatically and immediately sent to the plurality of receivers via the communication system when there is a change in the condition of the asset and further wherein the communication is encrypted.

16. The monitoring, communication and interface system of claim 15 further comprising a command module wherein the command module is associated with the information management system.

17. The monitoring, communication and interface system of claim 16 wherein the information management system receives instructions from the command module relating to the monitoring of the asset.

18. The monitoring, communication and interface system of claim 15 wherein the communication system is selected from the group consisting of a WiFi network, a cellular network, a satellite network and combinations thereof.

19. The monitoring, communication and interface system of claim 15 wherein the encrypted communication sent to the plurality of receivers is encrypted using multi-factor authentication.

20. The monitoring, communication and interface system of claim 15 wherein the plurality of receivers includes a first receiver and a second receiver, and wherein the communication is sent to the first receiver and the second receiver, and further wherein the communication sent to the first receiver is encrypted to form a first encrypted message and the communication sent to the second receiver is encrypted to form a second encrypted message, wherein the first encrypted message and the second encrypted message are encrypted differently.
